(19) United States
(12) Patent Application Publication
(10) Pub. No.: US 2015/0133149 A1
(43) Pub. Date: May 14, 2015

(54) APPARATUS AND METHOD FOR RECOGNIZING LOCATION OF TERMINAL BASED ON RADIO FINGERPRINT MAP

(71) Applicant: Electronics and Telecommunications Research Institute, Daejeon (KR)

(72) Inventors: Jooyoung KIM, Daejeon (KR); Youngsu CHO, Daejeon (KR); MyungIn JI, Daejeon (KR); Yang Koo LEE, Cheongju-si (KR); Sang Joon PARK, Daejeon (KR)

(73) Assignee: Electronics and Telecommunications Research Institute, Daejeon (KR)

(21) Appl. No.: 14/284,124

(22) Filed: May 21, 2014

(30) Foreign Application Priority Data
Nov. 8, 2013 (KR) 10-2013-0135854

(51) Int. Cl. H04W 64/00

(52) U.S. Cl. CPC H04W 64/00
USPC 455/456.1

(57) ABSTRACT

An apparatus for recognizing the location of a terminal based on a radio fingerprint map corrects a radio pattern received by a user terminal based on a difference in reception sensitivity between a reference terminal serving as a reference for the creation of a radio fingerprint map and the user terminal, and estimates the location of the user terminal by comparing the corrected radio pattern of the user terminal with the radio patterns in the radio fingerprint map.

### CROSS-REFERENCE TO RELATED APPLICATION

This application claims priority to and the benefit of Korean Patent Application No. 10-2013-0135854 filed in the Korean Intellectual Property Office on Nov. 8, 2013, the entire contents of which are incorporated herein by reference.

### BACKGROUND OF THE INVENTION

(a) Field of the Invention

The present invention relates to an apparatus and method for recognizing the location of a terminal based on a radio fingerprint map, and more particularly, to an apparatus and method for recognizing the location of a terminal which provide accurate location information regardless of the type of user terminal sending a location recognition request, by correcting pattern distortions caused by differences in receiving sensitivity between different types of terminals in radio fingerprint map-based location recognition using dynamic collection.

(b) Description of the Related Art

As numerous smart devices such as tablets, smartphones, etc. have been developed and the number of users has dramatically increased in recent years, commonly used radio communication infrastructures such as Wi-Fi, Bluetooth, etc. are becoming diverse. Also, various location-based services (LBS) using such infrastructures are being developed as typical services using a smartphone.

In order to provide various location-based services and applications in a broader range of environments, the precise location of a user needs to be identified in the first place. To this end, GPS (Global Location measurement server System) technology is typically used. GPS provide precise measurement of locations anytime and anywhere in almost every outdoor environment, except in some places such as a downtown area with many high-rise buildings, but has the drawback that it does not work indoors, where satellite signals cannot be received.

To solve this problem, a number of techniques using a radio communication infrastructure have been developed. Among them, radio fingerprint map-based location recognition technology shows the highest location recognition performance, without additional equipment in an indoor environment. Radio fingerprint map-based location recognition is a technology which divides an indoor space into particular areas, builds a radio fingerprint map storing radio patterns, i.e., radio fingerprints, for a particular or several infrastructures, which are received by each area, and upon a request for location recognition from a user of a location recognition service, compares a radio pattern received by a user with the radio patterns in the radio fingerprint map and recognizes the location of the proximate radio pattern as the user's location.

To this end, radio fingerprint map-based location recognition includes the collection and radio fingerprint map creation step and the location recognition step. The collection and radio fingerprint map creation step is a step of collecting a signal in an indoor space, acquiring radio patterns for each particular area, and building a radio fingerprint map. The location recognition step is a step of recognizing the location by pattern matching using the radio pattern received by the user. Accordingly, the radio fingerprint map should present the radio pattern of the relevant area correctly in order to accurately identify the user's location. The collection and radio fingerprint map creation step is performed using static collection or dynamic collection, and the location recognition step is performed by a server-based location measurement server or a terminal-based location measurement server, depending on which side does the location recognition.

A method generally used to build a radio fingerprint map in the collection and radio fingerprint map creation step is one using static collection. Static collection entails selecting a particular spot (e.g., the center) of an area (collection area) divided from an indoor space and collecting received radio waves while spending several minutes at the selected area. By taking the average of collected radio patterns, a radio fingerprint map is built. However, static collection is problematic in that it takes too much labor and time for collection because each of many collection spots in the indoor space requires several minutes of collection time. Due to this, it is virtually impossible for a location-based service targeting a broad service area to provide radio fingerprint map-based location recognition using static collection.

To solve this problem, dynamic collection was proposed, in which radio patterns are collected while moving around an indoor space, by using a device (collection device) capable of finding a real-time location by a sensor or GPS embedded in a smartphone and collecting radio signal information such as Wi-Fi or Bluetooth.

Creating a radio fingerprint map using dynamic collection has the advantage of minimizing the time and cost required for collection. However, this method yields lower data reliability than using static collection, which can acquire sufficient data with stability at one spot, because signal information is collected while moving. Also, it is difficult to acquire sufficient data unless a special scanning device is developed. This leads to an overall decrease in the quality of collected data.

Meanwhile, as devices using a radio communication infrastructure become more and more diverse, communication chipsets to be used in these devices are also becoming diverse. Each communication chipset has its own features, so the measured sensitivity of a received signal varies even if the same signal is received in the same environment, and the mean difference can be up to a dozen decibel-milliwatts (dBm) depending on the communication chipset. Accordingly, the result of location recognition may vary depending on whether signals are collected using different terminals in the same collection area or not, or which communication chipset a user terminal is using even if a normal radio fingerprint map collected by the same terminal is put into use.

Particularly, since dynamic collection has relatively low quality of collected data, which is the basis for the creation of a radio fingerprint map, the accuracy of a radio fingerprint map created by this method is inevitably lower than that of static collection. In addition to this, if there is any error in the reception sensitivity for a radio pattern, the performance of recognition of a user location becomes worse. This creates a demand for a system which is capable of providing users of any device with location estimates of similar accuracy.

### SUMMARY OF THE INVENTION

The present invention has been made in an effort to provide an apparatus and method for recognizing the location of a terminal based on a radio fingerprint map, and which prevent degradation of location recognition performance depending on the type of terminal.

An exemplary embodiment of the present invention provides an apparatus for recognizing the location of a terminal based on a radio fingerprint map. The apparatus for recognizing the location of a terminal based on a radio fingerprint map includes a radio fingerprint map DB, a reception sensitivity difference DB, and a location recognizer. The radio fingerprint map DB stores a radio fingerprint map having radio patterns for each location with reference to a reference terminal. The radio fingerprint map DB stores differences in reception sensitivity between the reference terminal and terminals of other types. The location recognizer corrects any error in radio pattern caused by differences in reception sensitivity between the reference terminal and a user terminal that has sent a location recognition request, with reference to the reception sensitivity difference DB, and recognizes the location of the user terminal by using the corrected radio pattern.

The apparatus for recognizing the location of a terminal based on a radio fingerprint map may further include a collector. The collector creates the radio fingerprint map by correcting the radio pattern of a radio signal collected for each location by a collecting terminal with the radio pattern of the reference terminal, with reference to the reception sensitivity difference DB.

The collector may correct the radio pattern for each location collected by the collecting terminal by subtracting the difference in reception sensitivity between the reference terminal and the collecting terminal from the radio pattern for each location collected by the collecting terminal.

The location recognizer may include a radio pattern corrector and a location estimator. The radio pattern corrector corrects the radio pattern of the user terminal with the radio pattern of the reference terminal, with reference to the reception sensitivity difference DB. The location estimator compares the corrected radio pattern of the user terminal with the radio patterns in the radio fingerprint map, and estimates the location of the radio pattern in the radio fingerprint map proximate to the corrected radio pattern of the user terminal as the location of the user terminal.

The radio pattern corrector may correct the radio pattern of the user terminal based on the difference in reception sensitivity between the reference terminal and the user terminal.

The location recognizer may include a radio pattern corrector and a location estimator. The radio pattern corrector corrects the radio patterns in the radio fingerprint map with the radio pattern of the user terminal, based on the reception sensitivity difference DB. The location estimator compares the corrected radio patterns in the radio fingerprint map with the radio pattern of the user terminal, and estimates the location of the radio pattern in the radio fingerprint map proximate to the radio pattern of the user terminal as the location of the user terminal.

Another exemplary embodiment of the present invention provides a method for a location measurement server to recognize the location of a terminal based on a radio fingerprint map. The method for recognizing the location of a terminal based on a radio fingerprint map includes: receiving a radio pattern received by a user terminal from the user terminal that has sent a location recognition request; correcting the radio pattern of the user terminal based on a difference in reception sensitivity between a reference terminal serving as a reference for the creation of a radio fingerprint map and the user terminal; and estimating the location of the radio pattern in the radio fingerprint map proximate to the corrected radio pattern of the user terminal as the location of the user terminal.

The correcting may include detecting the difference in reception sensitivity between the reference terminal and the type of the user terminal, with reference to a reception sensitivity difference DB storing differences in reception sensitivity between the reference terminal and terminals of other types.

The receiving may include receiving identification of the user terminal, and the detecting may include detecting the type of the user terminal based on the identification information of the user terminal.

The method for recognizing the location of a terminal based on a radio fingerprint map may further include: correcting the radio pattern of a radio signal collected for each location by a collecting terminal with the radio pattern of the reference terminal; and creating the radio fingerprint map by using the corrected radio pattern of the collecting terminal.

The correcting of the radio pattern of a radio signal collected for each location by a collecting terminal with the radio pattern of the reference terminal may include correcting the radio pattern for each location collected by the collecting terminal with the radio pattern of the reference terminal, based on the difference in reception sensitivity between the collecting terminal and the reference terminal.

Yet another exemplary embodiment of the present invention provides a method for a user terminal to recognize the location of a terminal based on a radio fingerprint map. The method for recognizing the location of a terminal based on a radio fingerprint map includes: sending a request for a radio fingerprint map to a location measurement server; receiving a difference in reception sensitivity between a reference terminal serving as a reference for the creation of a radio fingerprint map and the user terminal from the location measurement server; correcting the radio pattern of a radio signal received by the user terminal, based on the difference in reception sensitivity; and estimating the location of the radio pattern in the radio fingerprint map proximate to the corrected radio pattern of the user terminal as the location of the user terminal.

The correcting may include subtracting the difference in reception sensitivity between the reference terminal and the user terminal from the radio pattern of the user terminal.

A further exemplary embodiment of the present invention provides a method for a user terminal to recognize the location of a terminal based on a radio fingerprint map. The method for recognizing the location of a terminal based on a radio fingerprint map includes: sending a request for a radio fingerprint map to a location measurement server; receiving, from the location measurement server, the radio fingerprint map, which is corrected by the location measurement server based on a difference in reception sensitivity between a reference terminal serving as a reference for the creation of a radio fingerprint map and the user terminal; correcting the radio pattern of a radio signal received by the user terminal, based on the difference in reception sensitivity; and estimating the location of the radio pattern in the radio fingerprint map proximate to the radio pattern of a radio signal received by the user terminal as the location of the user terminal.

The receiving may include the location measurement server correcting the radio patterns in the radio fingerprint map with the radio pattern of the user terminal, based on the difference in reception sensitivity between the reference terminal and the user terminal.

### BRIEF DESCRIPTION OF THE DRAWINGS

FIG. 1 is a view showing an apparatus for recognizing a location of a terminal based on a radio fingerprint map according to an exemplary embodiment of the present invention.

FIGS. 2 to 4 are views showing an example of implementation of the apparatus for recognizing the location of a terminal base on a radio fingerprint map according to the exemplary embodiment of the present invention.

FIG. 5 is a view for explaining an example of a method of building the reception sensitivity difference DB of FIG. 1.

FIG. 6 is a view showing a server-based location recognition method according to an exemplary embodiment of the present invention.

FIG. 7 is a view showing an example of a terminal-based location recognition method according to an exemplary embodiment of the present invention.

FIG. 8 is a view showing another example of the terminal-based location recognition method according to an exemplary embodiment of the present invention.

FIG. 9 and FIG. 10 are graphs showing differences in reception sensitivity between different types when radio signals from two different signal transmitters are actually received at the same location.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising” will be understood to imply the inclusion of stated elements but not the exclusion of any other elements.

Now, an apparatus and method for recognizing the location of a terminal based on a radio fingerprint map according to an exemplary embodiment of the present invention will be described in detail with reference to the drawings.

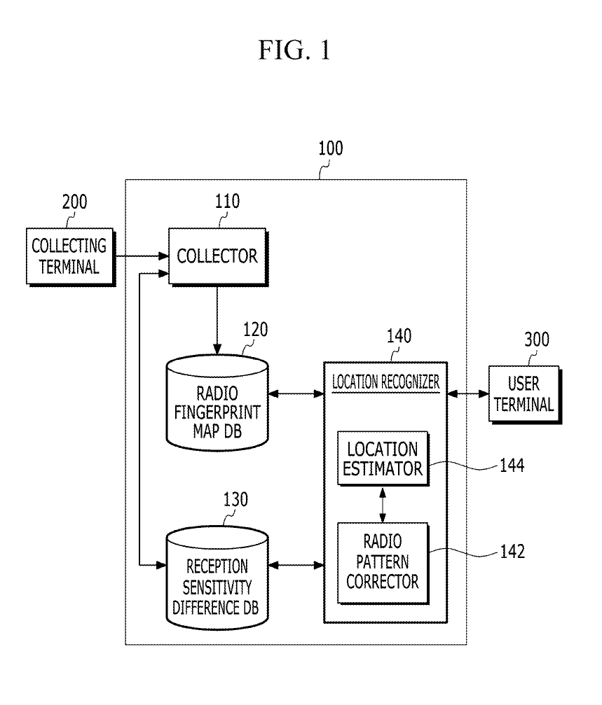

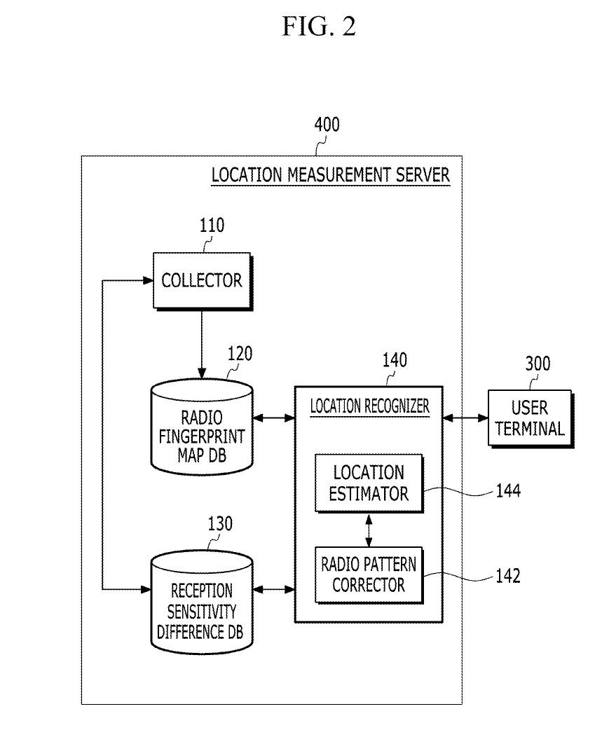

FIG. 1 is a view showing an apparatus for recognizing the location of a terminal based on a radio fingerprint map according to an exemplary embodiment of the present invention, and FIGS. 2 to 4 are views showing an example of implementation of the apparatus for recognizing the location of a terminal base on a radio fingerprint map according to the exemplary embodiment of the present invention.

Referring to FIG. 1, the apparatus 100 for recognizing the location of a terminal based on a radio fingerprint map includes a collector 110, a radio fingerprint map database (DB) 120, a reception sensitivity difference DB 130, and a location recognizer 140.

The collector 110 receives radio patterns collected by a collecting terminal 200. The collecting terminal 200 is a terminal which is capable of finding the location by a sensor or GPS and collecting radio signal information such as Wi-Fi or Bluetooth. The collecting terminal 200 collects radio patterns of radio signals while moving around an indoor space, and transmits the radio patterns and information about the locations from which the radio patterns are collected to the collector 110.

The collector 110 calculates the average of radio patterns of locations collected by the collecting terminal 200 and creates a radio fingerprint map to be used for location recognition using the average of radio patterns, and stores the radio fingerprint map in the radio fingerprint map DB 120. The radio fingerprint map stores radio patterns for each location in the indoor space. The collector 110 corrects the radio patterns collected by the collecting terminal 200 with the radio patterns of a reference terminal, and creates a radio fingerprint map by using the corrected radio patterns and information about the locations from which the radio patterns are collected. The reference terminal is a terminal which serves as a reference for the creation of a radio fingerprint map, and the reference terminal may be of the same type as or a different type from the collecting terminal 200. If the reference terminal is of the same type as the collecting terminal 200, the collector 110 creates a radio fingerprint map by using the radio patterns collected by the collecting terminal 200 as it is. On the other hand, if the reference terminal is of a different type from the collecting terminal 200, the collector 110 creates a radio fingerprint map after correcting the radio patterns collected by the collecting terminal 200 with the radio pattern of the reference terminal. Since the object that receives location information is, in general, a user of a location-based service, the type of terminal expected to be used most often by users (e.g., the type of terminal with the largest market share in the country to which service is provided) can be designated as the reference terminal.

The radio fingerprint DB 120 stores the radio fingerprint map of each individual indoor space.

The reception frequency difference DB 130 stores differences in reception sensitivity between different types of terminals. The reception sensitivity difference DB 130 stores differences in reception sensitivity between different types of terminals with reference to the reference terminal. The reception sensitivity difference DB 130 is a DB of differences in reception sensitivity between various collecting terminals, which is created in order to correct differences in radio reception sensitivity between different types of terminals, by measuring a radio signal in various environments and analyzing statistical characteristics to use them for radio pattern correction purposes. Although location-based services using radio fingerprint map-based location recognition generally provide signal measurements in office environments because they usually cover indoor areas where GPS is not available, they can be implemented in various ways under proper environments for various service scenarios.

The location recognizer 140 includes a radio pattern corrector 142 and a location estimator 144.

The radio pattern corrector 142 identifies the type of a user terminal 300 that has sent a location recognition request. If the user terminal 300 and the reference terminal are of different types, the radio pattern corrector 142 corrects a radio pattern received by the user terminal 300 with the radio pattern of the reference terminal, based on the reception sensitivity difference DB 130, and transmits the corrected radio pattern of the user terminal 300 to the location estimator 144. If the user terminal 300 and the reference terminal are of different types, the radio pattern corrector 142 can also correct the radio patterns in the radio fingerprint map with the radio pattern of the user terminal 300, based on the reception sensitivity difference DB 130, and transmit the corrected radio fingerprint map to the location estimator 144.

If the reference terminal which serves as a reference for the creation of a radio fingerprint map and the user terminal 300 are of different types, there can be a difference in reception sensitivity between them. Due to this, the radio pattern of the reference terminal and the radio pattern of the user terminal 300 are different at the same location, and this can cause an error in location recognition. Accordingly, the radio pattern corrector 142 corrects the radio pattern received by the user terminal 300 with the radio pattern of the reference terminal, thereby enabling accurate location recognition regardless of the type of the user terminal 300.

Upon receiving a location recognition request from the user terminal 300, the location estimator 144 compares the radio pattern received by the user terminal 300 with the radio patterns in the radio fingerprint map, and estimates the location of the proximate radio pattern in the radio fingerprint map as the location of the user terminal 300.

As such, the apparatus 100 for recognizing the location of a terminal based on a radio fingerprint map provides stable and accurate location service regardless of the type of the user terminal 300 because the location of the user terminal 300 is recognized by creating a radio fingerprint map with reference to the radio pattern of the reference terminal, and correcting any error in radio pattern caused by a difference in reception sensitivity between the user terminal 300, which has sent the location recognition request, and the reference terminal.

In the apparatus 100 for recognizing the location of a terminal based on a radio fingerprint map, location recognition can be classified into server-based location recognition and terminal-based location recognition depending on which side does the location recognition.

In case of server-based location recognition, as shown in FIG. 2, the collector 110, the radio fingerprint map DB 120, the reception sensitivity difference DB 130, and the location recognizer 140 may be formed in a location measurement server 400.

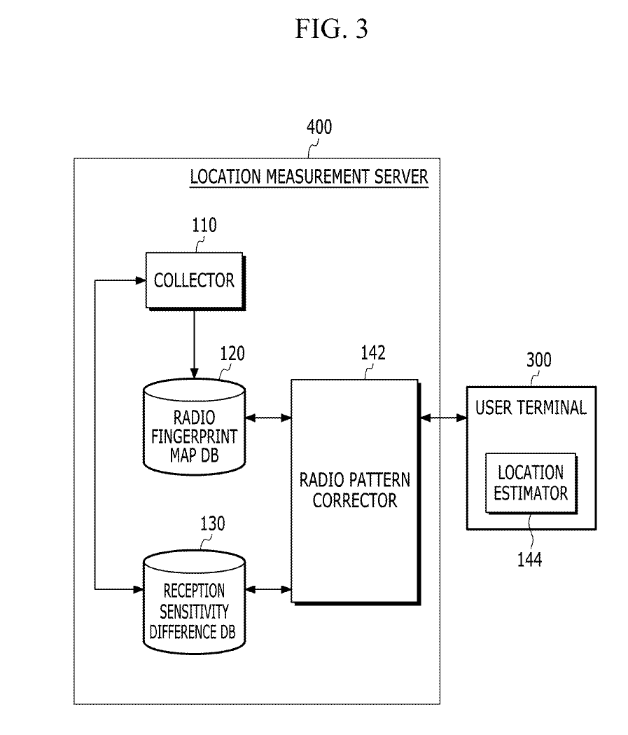

In case of terminal-based location recognition, the method of correction by the radio pattern corrector 142 may differ depending on which side does the radio pattern correction. If the location measurement server 400 does the radio pattern correction in terminal-based location recognition, the collector 110, the radio fingerprint map DB 120, the reception sensitivity difference DB 130, and the radio pattern corrector 142 may be formed in the location measurement server 400, and the location estimator 144 may be formed in the user terminal 300, as shown in FIG. 3. In this case, if the user terminal 300 and the reference terminal are of different types, the radio pattern corrector 142 may correct the radio patterns in the radio fingerprint map with the radio pattern of the user terminal 300, based on the reception sensitivity difference DB 130, and transmit the corrected radio fingerprint map to the location estimator 144 of the user terminal 300.

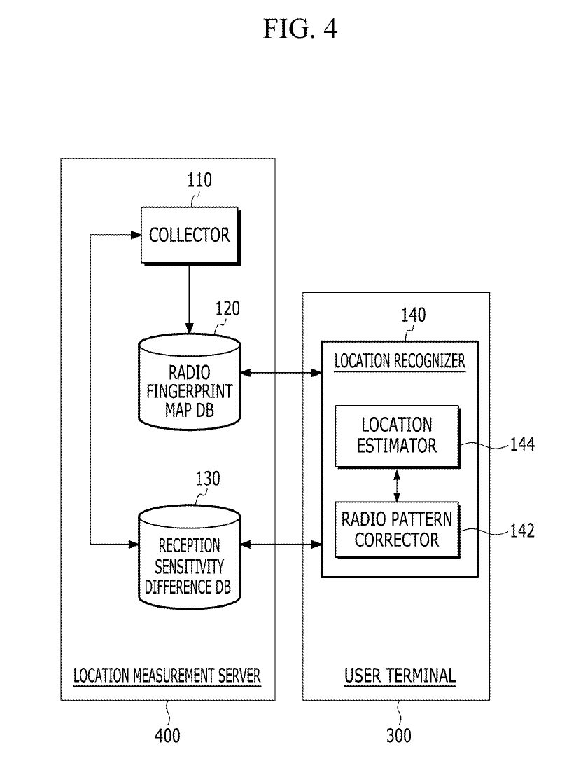

If the user terminal 300 does the radio pattern correction in terminal-based location recognition, the collector 110, the radio fingerprint map DB 120, and the reception sensitivity difference DB 130 may be formed in the location measurement server 400, and the location recognizer 140 may be formed in the user terminal 300, as shown in FIG. 4.

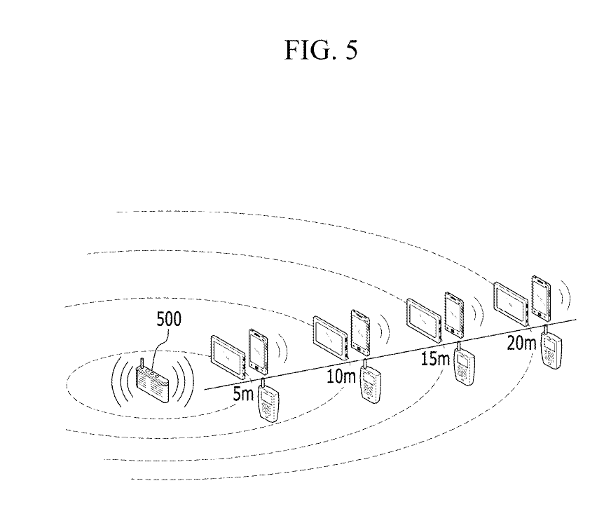

FIG. 5 is a view for explaining an example of a method of building the reception sensitivity difference DB of FIG. 1, which depicts an example of the signal measurement method for creating the reception sensitivity difference DB 130 in an office environment. The reception sensitivity difference DB 130 can be created in the same manner in environments other than the office.

As shown in FIG. 5, in order to accurately measure differences in reception sensitivity between different types, points spaced apart at specific intervals (e.g., 5 m) from a radio signal transmitter (e.g., a Wi-Fi access point) 500 are established, and radio signals received from a number of different types of terminals are collected several tens of times at these points. The reason why radio signals are received at a number of points is because differences between different types may vary depending on the sensitivity level of a received signal. For example, assuming that there are a terminal A and a terminal B, which are of different types, while terminal B receives signals at the reception sensitivity of −55 dBm on average in an environment where terminal A receives signals at −40 dBm on average, terminal B might receive signals at −85 dBm on average in an environment where terminal A receives signals at −80 dBm on average because the difference in reception sensitivity becomes smaller in regions where signals are weaker. The reason why signals are collected a number of times at one point is because it is difficult to build a reliable reception sensitivity difference DB 130 by making a signal sensitivity measurement only once due to the constantly-changing reception sensitivity of radio signals, caused by several factors including noise and a multipath phenomenon, and it is appropriate to receive signals a number of times and use statistical characteristics.

After collecting radio signals in this way, differences in reception sensitivity between different types are calculated each time the signals are received at each given distance, and statistical values of these differences are put together to create the reception sensitivity difference DB 130. The statistical values to be put into a database can be used in various ways depending on the method of radio pattern correction.

Table 1 shows an example of the reception sensitivity difference DB 130 which is created from mean differences in reception sensitivity between different types and standard deviations, taking into account external environmental factors such as distance.

TABLE 1

| | Distance | | | | | | |
|---|---|---|---|---|---|---|---|
| | 1 m | | 5 m | | 10 m | | |
| | | Standard | | Standard | | Standard | |
| Type | Mean | Deviation | Mean | Deviation | Mean | Deviation | |
| Reference | −24 | 0.7 | −43 | 0.3 | −57 | 0.1 | . . . |
| terminal | | | | | | | |
| (type 1) | | | | | | | |
| Type 2 | −8.5 | 0.8 | −10.1 | 1.7 | −9.8 | 1.1 | . . . |
| Terminl | | | | | | | |
| Type 3 | +3.2 | 0.3 | +4.3 | 1.2 | +67 | 0.7 | . . . |
| Terminal | | | | | | | |
| . . . | . . . | . . . | . . . | . . . | . . . | . . . | . . . |

In Table 1, the reference terminal denotes a reference terminal used to create a radio fingerprint map. That is, the reference terminal used to create a radio fingerprint map is also used as a reference for the creation of the reception sensitivity difference DB 130.

Referring to Table 1, because differences in mean and standard deviation are not statistically significant in the reference terminal, the mean reception sensitivity at a given distance and the standard deviation can be set for the reference terminal. That is, the reference terminal receives signals at the mean reception sensitivity of −24 dBm with a standard deviation of 0.7 at a 1 m distance. The Type 2 terminal receives signals at −32.5 dBm at a 1 m distance. The mean difference in reception sensitivity between the Type 2 terminal and the reference terminal is −8.5 dBm, and the standard deviation is 0.8. Likewise, the Type 3 Terminal receives signals at −20 dBm at a 1 m distance. The mean difference in reception sensitivity between the Type 3 terminal and the reference terminal is +3.2 dBm, and the standard deviation is 0.3.

The reason why the DB uses the 1 m distance is because the 1 m distance is used in a variety of signal correction algorithms, including a path loss model in which the signal sensitivity at the 1 m distance is represented by Pₒ. That is, the DB uses the 1 m distance for data acquisition purposes. The reception sensitivity difference DB 130 can also be used to estimate a path loss model for the analysis of an indoor radio environment.

Differences in reception sensitivity between different types are usually caused by internal factors of terminals, such as the design of terminal antennas and the method of received signal strength calculation for a communication chipset.

Table 2 shows an example of the reception sensitivity difference DB 130 which is created from mean and standard deviations of differences in reception sensitivity, with no external environmental factor such as distance in a simplified manner. As a way to eliminate differences in reception sensitivity over distance, the method of measuring received signal strength at various distances and then taking the average can be used when creating the reception sensitivity difference DB 130.

TABLE 2

Difference in reception signal
strength between terminals

| Type | Mean | Standard deviation |
|---|---|---|
| Reference terminal | 0 | 0 |
| (Type 1 Terminal) | | |
| Type 2 Terminal | −8.5 | 0.8 |
| Type 3 Terminal | +3.2 | 0.3 |
| . . . | . . . | . . . |

In Table 1 and Table 2, the manufacturer, model name, or serial number of a terminal can be used as identification information for distinguishing different types. As differences in reception sensitivity are largely caused by differences between chipsets, the reception sensitivity difference DB 130 can be created for each wireless communication chipset, rather than for each terminal type.

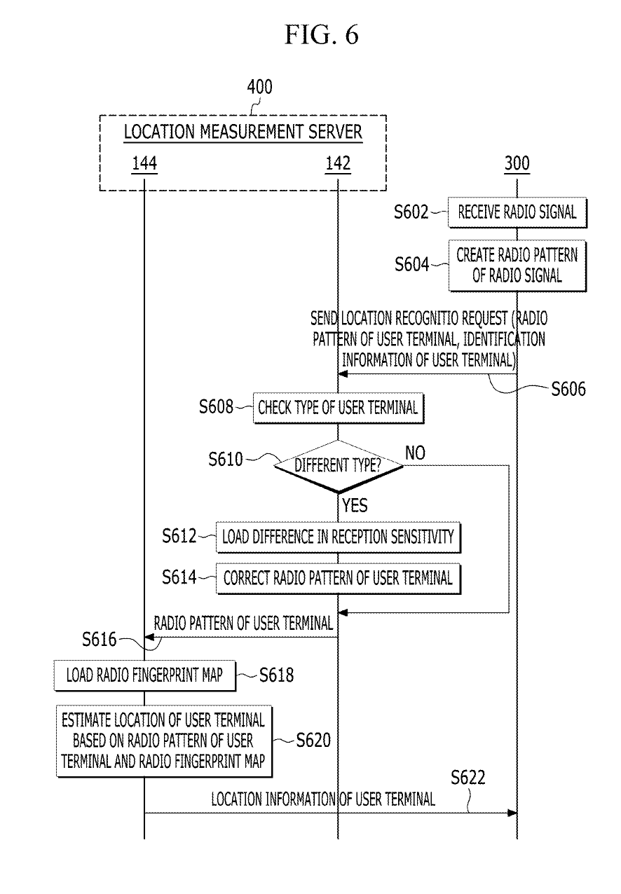

FIG. 6 is a view showing a server-based location recognition method according to an exemplary embodiment of the present invention. As shown in FIG. 2, the radio pattern corrector 142 and location estimator 144 of the location recognizer 140 can be formed at the location measurement server 400.

Referring to FIG. 6, upon receiving a location recognition request from the user, the user terminal 300 receives a radio signal around it (S602), generates a radio pattern for the received radio signal (S604), and sends the location measurement server 400 a request for location recognition while transmitting the radio pattern and identification information of the user terminal 300 to it (S606). The identification information of the user terminal 300 may be information for checking the type of the user terminal 300, or information of a wireless communication chipset.

The radio pattern corrector 142 checks whether the user terminal 300 and a reference terminal are of the same type, based on the identification information of the user terminal 300 (S608). If the user terminal 300 and the reference terminal are of different types (S610), the radio pattern corrector 142 searches for the difference in reception sensitivity for the type of the user terminal 300 in the reception sensitivity difference DB 130 and loads it (S612), corrects the radio pattern of the user terminal 300 with the radio pattern of the reference terminal, based on the difference in reception sensitivity for the type of the user terminal 300 (S614), and transmits the radio pattern of the user terminal 300 to the location estimator 144 (S616).

If the user terminal 300 and the reference terminal are of the same type, the radio pattern corrector 142 transmits the radio pattern of the user terminal 300 as it is received from the user terminal 300 to the location estimator 144 (S616).

Next, the location recognizer 140 loads a radio fingerprint map in the radio fingerprint map DB 120 (S618), compares the corrected radio pattern of the user terminal 300 with the radio patterns in the radio fingerprint map, and estimates the location of the radio pattern in the radio fingerprint map proximate to the radio pattern of the user terminal 300 as the location of the user terminal 300 (S620).

The location recognizer 140 transmits the estimated location of the user terminal 300 to the user terminal 300 (S622).

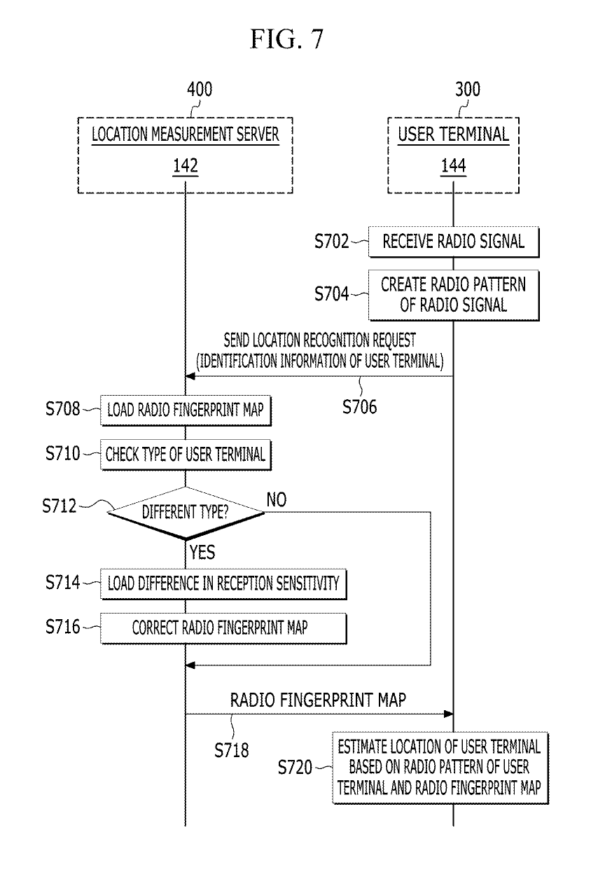

FIG. 7 is a view showing an example of a terminal-based location recognition method according to an exemplary embodiment of the present invention, in which radio pattern correction is performed in the location measurement server 400. In this case, as shown in FIG. 3, the radio pattern corrector 142 of the location recognizer 140 may be formed in the location measurement server 400, and the location estimator 144 may be formed in the user terminal 300.

Referring to FIG. 7, upon receiving a location recognition request from the user, the location estimator 144 of the user terminal 300 receives a radio signal around it (S702), and generates a radio pattern of the radio signal (S704).

The location estimator 144 sends a request for a radio fingerprint map while transmitting identification information of the user terminal 300 to the location measurement server 400 for location recognition purposes (S706).

Upon receiving the request for a radio fingerprint map, the radio pattern corrector 142 of the location measurement server 400 loads the radio fingerprint map in the radio fingerprint map DB 120 (S708).

The radio pattern corrector 142 then checks whether the user terminal 300 is of the same type as the reference terminal, based on the identification information of the user terminal 300 (S710). If the user terminal 300 and the reference terminal are of different types (S712), the radio pattern corrector 142 searches for the difference in reception sensitivity for the type of the user terminal 300 in the reception sensitivity difference DB 130 and loads it (S712).

The radio pattern corrector 142 corrects the loaded radio fingerprint map based on the difference in reception sensitivity for the type of the user terminal 300 (S716), and transmits the corrected radio fingerprint map to the user terminal 300 (S718). In this case, the radio pattern corrector 142 may correct a radio pattern of the loaded radio fingerprint map with the radio pattern for the type of the user terminal 300, based on the difference in reception sensitivity for the type of the user terminal 300. To provide faster service, the location measurement server 400 may correct the radio fingerprint map for all types of terminals expected to be serviced and store the radio fingerprint map corrected for different types of terminals in the radio fingerprint map DB 120, and upon a request for a radio fingerprint map from the user terminal 300, transmit the radio fingerprint map, which is corrected for the type of the user terminal 300, to the user terminal 300.

On the other hand, if the user terminal 300 and the reference terminal are of the same type, the radio pattern corrector 142 transmits to the user terminal 300 the loaded radio fingerprint map as it is (S718).

Upon receiving the radio fingerprint map from the location measurement server 400, the user terminal 300 compares the radio pattern of the user terminal 300 with the radio patterns in the radio fingerprint map by pattern matching, and estimates the location of the radio pattern in the radio fingerprint map proximate to the radio pattern of the user terminal 300 as the location of the user terminal (S720).

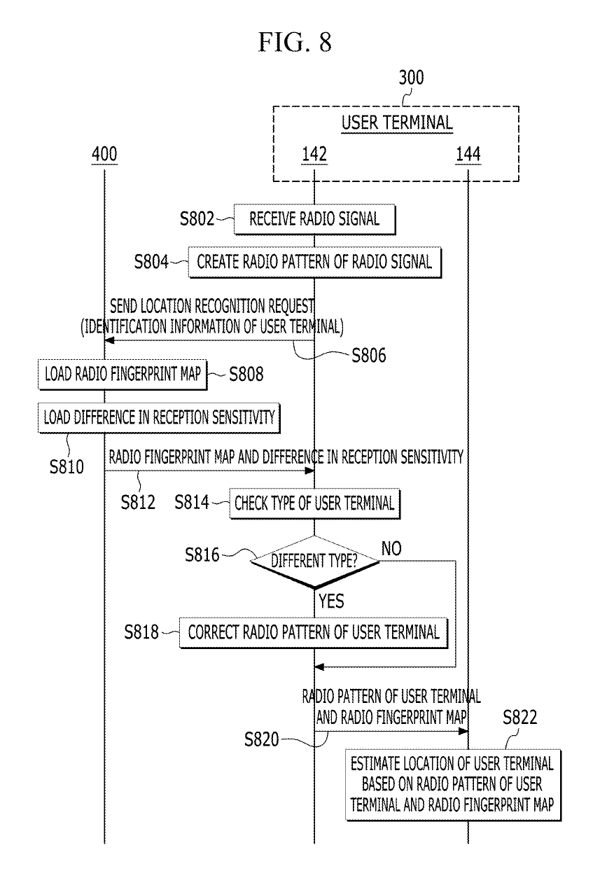

FIG. 8 is a view showing another example of the terminal-based location recognition method according to an exemplary embodiment of the present invention, in which radio pattern correction is performed in the user terminal 300. In this case, as shown in FIG. 4, the radio pattern corrector 142 and location estimator 144 of the location recognizer 140 may be formed in the user terminal 300.

Referring to FIG. 8, upon receiving a location recognition request from the user, the radio pattern corrector 142 of the user terminal 300 receives a radio signal around it (S802), and generates a radio pattern of the received radio signal (S804).

The radio pattern corrector 142 sends a request for a radio fingerprint map while transmitting identification information of the user terminal 300 to the location measurement server 400 for location recognition purposes (S806).

Upon receiving the request for a radio fingerprint map, the location measurement server 400 loads the radio fingerprint map in the radio fingerprint map DB 120 (S808), searches for the difference in reception sensitivity for the type of the user terminal 300 in the reception sensitivity difference DB 130, based on the identification information of the user terminal 300, and loads the difference in reception sensitivity for the type of the user terminal 300 from the reception sensitivity difference DB 130 (S810).

The location measurement server 400 transmits the loaded radio fingerprint map and the loaded difference in reception sensitivity for the type of the user terminal 300 to the radio pattern corrector 142 of the user terminal 300 (S812).

The radio pattern corrector 142 of the user terminal 300 checks whether the user terminal and the reference terminal are of the same type or not, based on the identification information of the user terminal 300 (S814). If the user terminal 300 and the reference terminal are of different types (S816), the radio pattern corrector 142 corrects the radio pattern of the user terminal 300 with the radio pattern of the reference terminal, based on the difference in reception sensitivity for the type of the user terminal 300 (S818), and transmits the corrected radio pattern of the user terminal 300 and the radio fingerprint map to the location estimator 144 (S820).

If the user terminal 300 and the reference terminal are of the same type, the radio pattern corrector 142 transmits the radio pattern of the user terminal 300 to the location estimator 144 as it is received from the user terminal 300, together with the radio fingerprint map (S820).

The location estimator 144 compares the radio pattern of the user terminal 300 with the radio patterns in the radio fingerprint map by pattern matching, and estimates the location of the radio pattern in the radio fingerprint map proximate to the radio pattern of the user terminal 300 as the location of the user terminal 300 (S822).

In FIG. 6 to FIG. 8, the radio pattern correction of the radio pattern corrector 142 may differ depending on the type of statistics compiled in the reception sensitivity difference DB 130 or depending on which algorithm is used for pattern matching of the location estimator 144. The commonly-available radio pattern correction method is to subtract the mean difference in reception sensitivity between the user terminal 300 and the reference terminal stored in the reception sensitivity difference DB 130 from the radio pattern of the user terminal 300 (or a radio pattern stored in the radio fingerprint map).

For example, assuming that location recognition is performed using K-NN in terminal-based location recognition, as shown in FIG. 8, the formula as shown in Equation 1 can be used.

$${d}_{j} = \sqrt{{\sum }_{i = 1}^{m} {( ( {S}_{i} - α ) - {s}_{ij} )}^{2}} \\ j = 1 , 2 , … n \qquad ( Equation 1 )$$

Equation 1 is a formula for calculating the distance in signal space between a radio pattern stored in the radio fingerprint map and a radio pattern received by the user terminal 300.

In Equation 1, Sᵢ is the signal sensitivity of an i-th signal transmitter in the radio pattern of the user terminal 300, a is the mean difference in reception sensitivity between the user terminal 300 and the reference terminal, and is the signal sensitivity of the i-th signal transmitter in a j-th radio pattern stored in the radio fingerprint map DB 120.

As shown in Equation 1, the radio pattern corrector 142 of the user terminal 300 can correct the radio pattern of the user terminal 300 by subtracting the mean difference in reception sensitivity between the user terminal 300 and the reference terminal from the radio pattern of the user terminal 300.

Also, the location estimator 144 of the user terminal 300 can calculate the user's location by measuring the distance d between the corrected radio pattern of the user terminal 300 and a radio pattern in the radio fingerprint map, detecting k reference locations for k proximate radio patterns in the signal space between the two radio patterns from the radio fingerprint map, and taking the average of the k reference locations by Equation 2.

$$( \hat{x} , \hat{y} ) = \frac{1}{k} {\sum }_{i = 1}^{k} ( {x}_{i} , {y}_{i} ) \qquad ( Equation 2 )$$

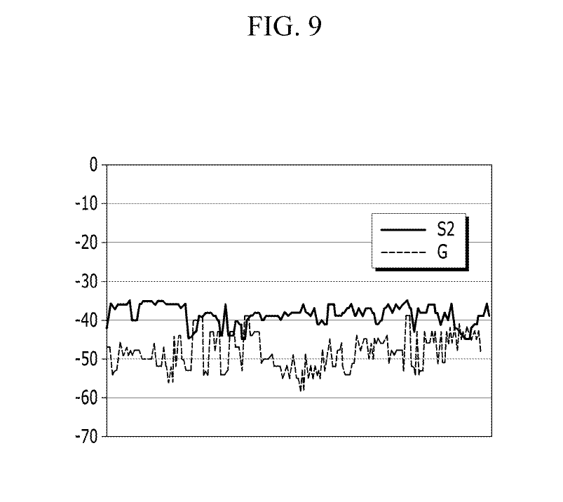

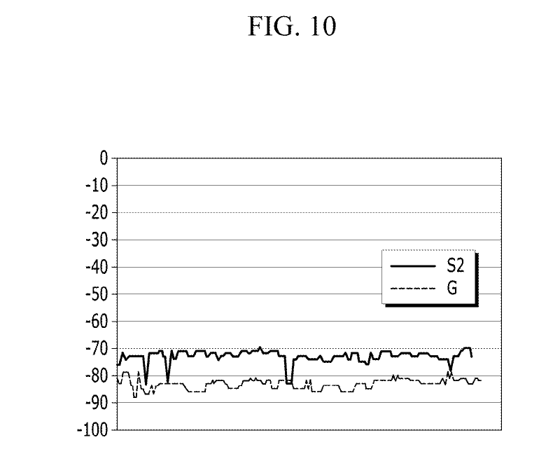

FIG. 9 and FIG. 10 are graphs showing the differences in reception sensitivity between different types when radio signals from two different signal transmitters are actually received at the same location. In FIG. 9 and FIG. 10, terminal S2 is a Galaxy S2 terminal, and terminal G is an Optimus G terminal.

Referring to the graph of FIG. 9, the mean reception sensitivity of terminal S2 is −38.55 dBm, and the mean reception sensitivity of terminal G is −48.41 dBm. Referring to the graph of FIG. 10, the mean reception sensitivity of terminal S2 is −73.06 dBm, and the mean reception sensitivity of terminal G is −83.22 dBm. Hence, the differences in reception sensitivity between the two terminals are 0.86 and 10.16 dBm, respectively.

As seen from the above, when radio signals received by a terminal are used for location recognition without correction, differences in reception sensitivity between different types of terminals can lead to a failure to create an accurate radio fingerprint map or generate errors in location recognition caused by radio pattern distortions. Accordingly, the apparatus 100 for recognizing the location of a terminal based on a radio fingerprint map according to an exemplary embodiment of the present invention provides accurate location information regardless of the type of user terminal sending a location recognition request, by correcting differences in receiving sensitivity between different types of terminals.

According to an embodiment of the present invention, it is possible to perform accurate location recognition regardless of the type of user terminal, by correcting radio pattern distortions caused by differences in receiving sensitivity between different types of terminals, in radio fingerprint map-based location recognition using dynamic collection.

An exemplary embodiment of the present invention may not only be embodied through the above-described apparatus and method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for recognizing the location of a terminal based on a radio fingerprint map, the apparatus comprising:
a radio fingerprint map database (DB) that stores a radio fingerprint map having radio patterns for each location with reference to a reference terminal;
a radio fingerprint map DB that stores differences in reception sensitivity between the reference terminal and terminals of other types; and
a location recognizer that corrects any error in radio pattern caused by differences in reception sensitivity between the reference terminal and a user terminal that has sent a location recognition request, with reference to the reception sensitivity difference DB, and recognizes the location of the user terminal by using the corrected radio pattern.

2. The apparatus of claim 1, further comprising a collector that creates the radio fingerprint map by correcting the radio pattern of a radio signal collected for each location by a collecting terminal with the radio pattern of the reference terminal, with reference to the reception sensitivity difference DB.

3. The apparatus of claim 2, wherein the collector corrects the radio pattern for each location collected by the collecting terminal by subtracting the difference in reception sensitivity between the reference terminal and the collecting terminal from the radio pattern for each location collected by the collecting terminal.

4. The apparatus of claim 1, wherein
the location recognizer comprises:
a radio pattern corrector that corrects the radio pattern of the user terminal with the radio pattern of the reference terminal, with reference to the reception sensitivity difference DB; and
a location estimator that compares the corrected radio pattern of the user terminal with the radio patterns in the radio fingerprint map, and estimates the location of the radio pattern in the radio fingerprint map proximate to the corrected radio pattern of the user terminal as the location of the user terminal.

5. The apparatus of claim 4, wherein the radio pattern corrector corrects the radio pattern of the user terminal based on the difference in reception sensitivity between the reference terminal and the user terminal.

6. The apparatus of claim 1, wherein
the location recognizer comprises:
a radio pattern corrector that corrects the radio patterns in the radio fingerprint map with the radio pattern of the user terminal, based on the reception sensitivity difference DB; and
a location estimator that compares the corrected radio patterns in the radio fingerprint map with the radio pattern of the user terminal, and estimates the location of the radio pattern in the radio fingerprint map proximate to the radio pattern of the user terminal as the location of the user terminal.

7. The apparatus of claim 6, wherein the radio pattern corrector corrects the radio patterns in the radio fingerprint map based on the difference in reception sensitivity between the reference terminal and the user terminal.

8. A method for a location measurement server to recognize the location of a terminal based on a radio fingerprint map, comprising:
receiving a radio pattern received by a user terminal from the user terminal that has sent a location recognition request;
correcting the radio pattern of the user terminal based on a difference in reception sensitivity between a reference terminal serving as a reference for the creation of a radio fingerprint map and the user terminal; and
estimating the location of the radio pattern in the radio fingerprint map proximate to the corrected radio pattern of the user terminal as the location of the user terminal.

9. The method of claim 8, wherein the correcting comprises detecting the difference in reception sensitivity between the reference terminal and the type of the user terminal, with reference to a reception sensitivity difference database (DB) storing differences in reception sensitivity between the reference terminal and terminals of other types.

10. The method of claim 9, wherein
the receiving comprises receiving identification of the user terminal, and
the detecting comprises detecting the type of the user terminal based on the identification information of the user terminal.

11. The method of claim 8, wherein the correcting comprises subtracting the difference in reception sensitivity between the reference terminal and the user terminal from the radio pattern of the user terminal.

12. The method of claim 8, further comprising:
correcting the radio pattern of a radio signal collected for each location by a collecting terminal with the radio pattern of the reference terminal; and
creating the radio fingerprint map by using the corrected radio pattern of the collecting terminal.

13. The method of claim 12, wherein the correcting of the radio pattern of a radio signal collected for each location by a collecting terminal with the radio pattern of the reference terminal comprises correcting the radio pattern for each location collected by the collecting terminal with the radio pattern of the reference terminal, based on the difference in reception sensitivity between the collecting terminal and the reference terminal.

14. The method of claim 8, further comprising transmitting the estimated location of the user terminal to the user terminal.

15. A method for a user terminal to recognize the location of a terminal based on a radio fingerprint map, the method comprising:
sending a request for a radio fingerprint map to a location measurement server;
receiving a difference in reception sensitivity between a reference terminal serving as a reference for the creation of a radio fingerprint map and the user terminal from the location measurement server;
correcting the radio pattern of a radio signal received by the user terminal, based on the difference in reception sensitivity; and
estimating the location of the radio pattern in the radio fingerprint map proximate to the corrected radio pattern of the user terminal as the location of the user terminal

16. The method of claim 15, wherein the correcting comprises subtracting the difference in reception sensitivity between the reference terminal and the user terminal from the radio pattern of the user terminal.

17. The method of claim 15, wherein
the sending of a request comprises transmitting identification information of the user terminal to the location measurement server, and
the receiving comprises detecting the difference in reception sensitivity between the reference terminal and the user terminal, with reference to a reception sensitivity difference database (DB) storing differences in reception sensitivity between the reference terminal and terminals of other types, by using the identification information of the user terminal.

18. A method for a user terminal to recognize the location of a terminal based on a radio fingerprint map, the method comprising:
sending a request for a radio fingerprint map to a location measurement server;
receiving, from the location measurement server, the radio fingerprint map, which is corrected by the location measurement server based on a difference in reception sensitivity between a reference terminal serving as a reference for the creation of a radio fingerprint map and the user terminal; and
estimating the location of the radio pattern in the radio fingerprint map proximate to the radio pattern of a radio signal received by the user terminal as the location of the user terminal.

19. The method of claim 18, wherein the receiving comprises the location measurement server correcting the radio patterns in the radio fingerprint map with the radio pattern of the user terminal, based on the difference in reception sensitivity between the reference terminal and the user terminal.

20. The method of claim 18, wherein
the sending of a request comprises transmitting identification information of the user terminal to the location measurement server, and
the receiving comprises detecting the difference in reception sensitivity between the reference terminal and the user terminal, with reference to a reception sensitivity difference DB storing differences in reception sensitivity between the reference terminal and terminals of other types than the reference terminal, by using the identification information of the user terminal.
